(19) United States
(12) Patent Application Publication
(10) Pub. No.: US 2021/0179772 A1
(43) Pub. Date: Jun. 17, 2021

(54) ENERGY STORAGE ELECTRODES FABRICATED FROM POROUS AND ELECTRONIC POLYMERS

(71) Applicant: THE TRUSTEES OF COLUMBIA UNIVERSITY IN THE CITY OF NEW YORK, New York, NY (US)

(72) Inventors: Colin Nuckolls, New York, NY (US); Xavier Sylain Roy, New York, NY (US); Yuan Yang, New York, NY (US); Thomas Sisto, New York, NY (US); Samuel Robert Peurifoy, New York, NY (US); Jake Carter Russell, New York, NY (US)

(73) Assignee: THE TRUSTEES OF COLUMBIA UNIVERSITY IN THE CITY OF NEW YORK, New York, NY (US)

(21) Appl. No.: 17/181,704

(22) Filed: Feb. 22, 2021

Related U.S. Application Data
(63) Continuation of application No. PCT/US2019/047787, filed on Aug. 22, 2019.
(60) Provisional application No. 62/721,460, filed on Aug. 22, 2018.

(51) Int. Cl. C08G 61/12; H01G 11/48

(52) U.S. Cl. CPC C08G 61/122; H01G 11/48; C08G 2261/124; C08G 2261/90; C08G 2261/3142; C08G 2261/411; C08G 2261/3241

(57) ABSTRACT

Methods for making electron accepting polymers, and polymers made thereby, are disclosed. The polymer can include a perylene diimide (PDI) subunit and a triptycene subunit. The disclosed polymer can accept an electron and be used as a pseudocapacitor material.

### CROSS-REFERENCE TO RELATED APPLICATIONS

This application is a continuation of International Patent Application No. PCT/US 2019/047787 filed Aug. 22, 2019, which claims the benefit of priority to U.S. Provisional Patent Application Ser. No. 62/721,460, filed Aug. 22, 2018, which are hereby incorporated by reference in their entireties.

### GRANT INFORMATION

This invention was made with government support under grant numbers N00014-17-1-2205 and N00014-16-1-2921 awarded by the Office of Naval Research (ONR) and FA9550-18-1-0020 awarded by the Air Force Office of Scientific Research (AFOSR). The government has certain rights in the invention.

### BACKGROUND

As renewable energy production technologies emerge, a need has developed for materials for storing and rapidly distributing energy. Certain capacitor and battery devices can support certain electrical energy storage systems, the former for rapid charge/discharge cycling, and the latter for long-term energy storage. Certain pseudocapacitors can incorporate elements of both batteries and capacitors, exhibiting a linear dependence of charge stored versus potential. The pseudocapacitors can be applied to applications that require charge storages at intermediate timescales, such as regenerative braking in electric vehicles.

Certain inorganic solid-state compounds included in pseudocapacitors can improve performance of the pseudocapacitors. However, inorganic solid-state compounds can provide limited synthetic tunability. Although certain organic materials can offer a modular framework paired with mild processing conditions, they can exhibit low capacitance, poor electrochemical stability and high resistivity.

Thus, there is a need for tunable electroactive materials which can improve performance of pseudocapacitors.

### SUMMARY

The disclosed subject matter provides tunable electroactive materials to improve pseudocapacitor performance. In some embodiments, the disclosed subject matter provides a polymer that can include a perylene diimide (PDI) subunit and a triptycene subunit. The polymer can accept an electron and be used as a pseudocapacitor material. In certain embodiments, the PDI subunit and the triptycene subunit can be polymerized via a Suzuki polymerization. In non-limiting embodiments, the PDI subunit can include 1,6-, 1,7-dibromoperylene-3,4,9,10-tetracarboxylicdiimide, or a mixture of thereof. In some embodiments, the triptycene subunit is triptycene tris-boronic acid pinacol ester.

In certain embodiments, the disclosed polymer can be configured to have a capacitance value between about 0 F/g and about 350 F/g at a current density about 0.2 A/g. In non-limiting embodiments, capacitance properties of the polymer can be stable for more than 10,000 cycles. For example, the disclosed polymer can maintain its Coulombic efficiency above 95% after 10,000 cycles.

The disclosed subject matter also provides methods of making electron accepting polymers. An example method can include creating a polymer by polymerizing a perylene diimide (PDI) subunit and a triptycene subunit, thermolyzing the polymer, washing the polymer with organic solvents, photocyclizing the polymer to generate a triptycene-PDI polymer, and thermolyzing the triptycene-PDI polymer. In certain embodiments, the method can further include depositing a slurry of the triptycene-PDI polymer, carbon black, and polytetrafluoroethylene onto a nickel (Ni) foam to make an electrode. In non-limiting embodiments, the method can also include modifying a pore structure of the triptycene-PDI polymer via flow photocyclization for altering the performance of the disclosed polymer. In some embodiments, the polymerizing can be a Suzuki polymerization. The disclosed PDI subunit can include 1,6-, 1,7-dibromoperylene-3,4,9,10-tetracarboxylicdiimide, or a mixture of thereof. The disclosed triptycene subunit can be triptycene tris-boronic acid pinacol ester.

### BRIEF DESCRIPTION OF THE DRAWINGS

Further features and advantages of the present disclosure will become apparent from the following detailed description taken in conjunction with the accompanying figures showing illustrative embodiments of the present disclosure, in which:

FIG. 1 is a schematic diagram illustrating an example hexagonal macrocyclic pore subunit and the molecular structures of its building blocks in accordance with the disclosed subject matter.

FIGS. 2A-D provide (2A) a thermogravimetric analysis, (2B) Infrared spectra of the carbonyl region, (2C) Infrared spectra of the alkyl spectral region of example monomers and structures used to make the porous scaffold, and (2D) Density functional theory (DFT)-optimized energy minimum structure of a truncated fused macrocyclic subunit in accordance with the present disclosure.

FIGS. 3A-H provide current-voltage curves of an example structure 1 at (3A) higher and (3B) lower scan rates, current-voltage curves of an example structure 2 at (3C) higher and (3D) lower scan rates, and galvanostatic charge-discharge (GCD) curves of the example structure 1 at (3E) higher and (3F) lower currents, and GCD curves of the example structure 2 at (3G) higher and (3H) lower currents.

FIG. 4A is a graph illustrating capacitance of example structures in accordance with the present disclosure. FIG. 4B is a graph illustrating cycling stability of example structures in accordance with the present disclosure. FIG. 4C provides Nyquist plots of example structures in accordance with the present disclosure. FIG. 4D is a graph illustrating capacitance of example structures as a function of frequency in accordance with the present disclosure.

FIG. 5 is a schematic work flow for synthesizing an example polymer 1.

FIG. 6 is a schematic work flow for synthesizing an example polymer 2.

FIG. 7A is a graph illustrating N₂ adsorption isotherms of 1, Porous-1, 2 and Porous-2. FIG. 7B is a graph illustrating pore size distribution of 1, Porous-1, 2, Porous-2, and 1′ (low molecular weight 1).

FIG. 8 is a graph illustrating mass spectrum of an example monomer in accordance with the disclosed subject matter.

FIGS. 9A-D provide infrared (IR) spectra of (9A) 1, (9B) Porous-1, (9C) 2, and (9D) Porous-2. FIG. 9E provides IR spectra of 1, 2, Porous-1 and Porous-2, showing the carbonyl region. FIG. 9F provides IR spectra for 1, 2, Porous-1 and Porous-2, showing the alkyl spectral region.

FIG. 10 provides a ¹H NMR spectrum of 1 in CDCl₃.

FIG. 11 provides a ¹H NMR spectrum of 2 in CDCl₃.

FIGS. 12A-B provide the powder X-ray diffraction (PXRD) patterns of (12A) 1 and Porous-1 and (12B) 2 and Porous-2.

FIGS. 13A-D provide Scanning Electron Microscopy (SEM) images of (13A) 1, (13B) Porous-1, (13C) 2, and (13D) Porous-2.

FIG. 14A provides normalized electronic absorption spectra of 1 and 2 in dichloromethane solution. FIG. 14B provides diffuse reflectance solid state electronic absorption spectra of 1, 2, Porous-1 and Porous-2.

FIG. 15 is a schematic diagram of an example circuit for the pseudocapacitive system in accordance with the disclosed subject matter.

FIGS. 16A-D provide current-voltage curves of (16A) 1, (16B) 2, (16C) thermalized PDI, and (16D) carbon black. FIGS. 16E-H provide galvanostatic charge-discharge (GCD) curves of (16E) 1 at a current of 0.5 A/g, (16F) 1 at a current of 5 A/g, (16G) 2 at a current of 0.5 A/g, and (16H) Nyquist plots of 1, 2, Porous-1 and Porous-2.

FIGS. 17A-B provide current-voltage curves of Porous-1 at (17A) lower scan rates and (17B) higher scan rates. FIGS. 17C-D provide current-voltage curves of Porous-2 at (17C) lower scan rates and (17D) higher scan rates.

FIG. 18 is a graph illustrating coulombic efficiencies per cycle of Porous-1 and Porous-2.

FIGS. 19A-B provide plots of log(i) vs. log(v) for (19A) Porous-1 and (19B) Porous-2.

FIGS. 20A-C provide (20A) a DFT energy-minimized structure of Porous-2, (20B) a hexagonal pore subunit, and (20C) a cylindrical pore subunit in accordance with the disclosed subject matter.

FIG. 21 is a graph illustrating cycling stability of the disclosed polymer under various conditions in accordance with the disclosed subject matter.

FIG. 22 is a graph illustrating cyclic voltammograms of the disclosed polymer under various conditions in accordance with the disclosed subject matter.

FIG. 23 is a graph illustrating galvanostatic curves of the disclosed polymer under various conditions in accordance with the disclosed subject matter.

FIG. 24 is a graph illustrating performance of the disclosed polymer under various conditions in accordance with the disclosed subject matter.

Throughout the figures, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments.

### DETAILED DESCRIPTION

The disclosed subject matter provides a polymer and a method for developing thereof. An example polymer can include a perylene diimide (PDI) subunit and a triptycene subunit. The disclosed polymer can accept an electron.

The disclosed polymer can include a perylene diimide (PDI) subunit and a triptycene subunit. In certain embodiments, the disclosed polymer can be a porous scaffold which can be used as a pseudocapacitor material. For example, a perylene diimide (PDI) subunit and a triptycene subunit can be polymerized to make the porous scaffold through a Suzuki polymerization. The triptycene subunit can be triptycene tris-boronic acid pinacol ester. The PDI subunit can include 1,6-, 1,7-dibromoperylene-3,4,9,10-tetracarboxylicdiimide, or a mixture of thereof. The triptycene subunits can be synthesized by using C—H activation chemistry to achieve a single procedure borylation of triptycene. PDI can be coupled to the triptycene subunits by possessing internal free spaces to increase internal surface area and thermal stability. These structural properties, combined with the robust redox behavior of the PDI subunit, can produce n-type pseudocapacitance up to 350 F/g at a current density as high as 10 A/g. Furthermore, the disclosed polymer can have an improved stability. For example, the disclosed polymer can have a Coulombic efficiency of about 9598% after more than 10,000 cycles.

As used herein, the term “about” or “approximately” means within an acceptable error range for the value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

In certain embodiments, the internal surface of the disclosed polymer can increase by removing alkyl chains which occupy pore spaces. When the concentration of the original Suzuki polymerization as increase, an insoluble polymer can be synthesized via the Suzuki polymerization. Such an insoluble polymer can have alkyl chains which can occupy pores. The alkyl chains can be removed from the pores by thermolysis. For example, up to about 40% of the sample mass, corresponding to the mass of the alkyl chains, can be removed at about 400° C. In non-limiting embodiments, an example pore can have a diameter less than about 3 nanometers (nm). The thermolyzed solid and porous polymer can have a larger surface area than non-thermolyzed scaffold and provide improved electrochemical properties, as alkyl chain-mediated resistance is removed.

In certain embodiments, electrochemical and transport behaviors of the disclosed porous scaffold can be altered by modifying the post-synthesis structure. For example, performance of the polymer can be switched from a battery-like (storing more charge at low rates) function to a capacitor-like (faster charge cycling) function by modifying the structure of the pores via flow photocyclization.

In certain embodiments, an example porous scaffold can be applied to industrial applications which require tunable energy storage materials with wide range of capacitance values. For example, the disclosed scaffold can be used to improve automobile regenerative braking systems. The disclosed polymer can be also used for kinetic energy recovery systems (e.g., elevator, cranes, wind turbines) and flexible electronics (e.g., wearable tech).

In certain embodiments, the disclosed subject matter provides methods for making an electron accepting polymer. An example method can include creating a polymer by polymerizing a perylene diimide (PDI) subunit and a triptycene subunit. For example, the polymer can be made by performing polymerization of at least two monomers (e.g., triptycene tris-boronic acid pinacol ester and a mixture of 1,6- and 1,7-dibromoperylene-3,4,9,10-tetracarboxylicdiimide) to foam a polymer. An exemplary polymerization can be a palladium (Pd)-catalyzed Suzuki polymerization. In non-limiting embodiments, the polymer can be a soluble polymer or an insoluble polymer. By increasing the concentration of the original Suzuki polymerization, an insoluble polymer can be synthesized. Alternatively, by decreasing the concentration of the original Suzuki polymerization, a soluble polymer can be synthesized.

In certain embodiments, the disclosed method can include thermolyzing the polymer. For example, the polymer can be thermolyzed at about 375-400 Celsius (° C.) to make a plurality of pores in a vacuum tube.

In certain embodiments, the disclosed method can include washing the polymer with organic solvents. For example, the solvents can include methanol, hexanes, acetonitrile, chloroform, or combinations thereof.

In certain embodiments, the disclosed method can include photocyclizing the polymer to make a triptycene-PDI polymer. For example, the washed polymer can be photocyclized using visible light. The triptycene-PDI polymer can have an increased surface area relative to the washed polymer, as the photocyclization can stiffen the structure and increase the aromatic surface area. In non-limiting embodiments, the triptycene-PDI polymer can be a porous scaffold. In some embodiments, the triptycene-PDI polymer can be a cyclized triptycene-PDI polymer scaffold. In certain embodiments, the triptycene-PDI polymer can be further thermolyzed and washed with organic solvents.

In certain embodiments, the disclosed method can further include depositing a slurry of the triptycene-PDI polymer, carbon black, and polytetrafluoroethylene onto a nickel (Ni) foam to make an electrode. For example, electrodes can be fabricated by depositing a slurry of the porous scaffold (e.g., triptycene-PDI polymer), carbon black (e.g., 10 wt. %), and polytetrafluoroethylene (e.g., 10 wt. %) onto Nickel (Ni) foam. The slurry can be made by grinding the triptycene-PDI polymer in an agate mortar and pestle. The material can be combined with carbon-black and polytetrafluoroethylene (60% w/v suspension in water) in an 80/10/10 mass ratio. N-methyl-2-pyrrolidone (NMP) can be added to the mixture and the slurry can be stirred. The Ni foam can be sonicated in HCl to clean the surface of native oxide. The Ni foam can be washed with water and acetone, dried, and weighed on an analytical balance. Drops of the slurry can be deposited onto the Ni foam and dried. The electrode can be mechanically pressed, weighed, and placed back in a vacuum oven to dry.

In non-limiting embodiments, the disclosed electrode can accept an electron and function as a n-type pseudocapacitor. Electrochemical properties of the electrodes can be evaluated in aqueous electrolyte solution (e.g., 1 M Na₂SO₄) with a counter electrode (e.g., platinum electrode) and a reference electrode (e.g., silver/silver-chloride electrode). In some embodiments, exemplary electrochemical properties can include capacitance, cycling stability, charging rate, and resistance levels. For example, an example porous scaffold can produce n-type pseudocapacitance of about 350 F/g at a current density as high as about 10 A/g, and stability for more than about 10,000 cycles alongside a Coulombic efficiency of less than about 98%.

In certain embodiments, the disclosed method can further include modifying a structure of the polymer (e.g., the thermolyzed polymer, the washed polymer, and/or the triptycene-PDI polymer) to alter the performance of the polymer. For example, a pore structure of the polymer can be modified by cyclizing a backbone via flow photocyclization. The performance of the polymer can be altered from battery-like (e.g., storing more charge at low rates) to capacitor-like (e.g., faster charge cycling) by modifying the structure of the pores via flow photocyclization.

In non-limiting embodiments, the modified structure can improve the electrochemical properties of the porous scaffold. Certain porous cyclized material can outperform the porous uncyclized material at certain current densities. For example, certain porous uncyclized material can reaches a peak capacitance of 352 F/g at current density 0.2 A/g (59 mAh/g), while cyclized material can provide improved capacitance at higher current densities.

### Example 1—Designing Three-Dimensional Architectures for High-Performance Electron Accepting Pseudocapacitors

The presently disclosed subject matter will be better understood by reference to the following Example. The Example is provided as merely illustrative of the disclosed methods and systems, and should not be considered as a limitation in any way. Among other features, the example illustrates example devices and techniques for making three-dimensional architectures for electron accepting pseudocapacitors

The disclosed pseudocapacitors can incorporate elements of both batteries and capacitors, exhibiting a linear dependence of charge stored versus potential as a consequence of surface-level Faradaic electron-transfer processes. These devices can require charge storage at intermediate timescales, such as regenerative braking in electric vehicles. High performance pseudocapacitors can be made from inorganic solid state compounds with limited synthetic tunability. Organic materials can be used because they can offer a modular framework paired with mild processing conditions. Certain organic pseudocapacitor materials, however, are electron donating (i.e., p-type), meaning the charge storage process is oxidative; in general, electron accepting (i.e., n-type) materials exhibit low capacitance, poor electrochemical stability and high resistivity. To achieve a wide potential range and high practical capacitance, both electron accepting and electro releasing material can be required to fabricate pseudocapacitor devices.

The presently disclosed subject matter provides a porous architecture constructed from perylene diimide (PDI) and triptycene subunits which can perform as an n-type pseudocapacitor material. The disclosed PDI can have various suitable chemical and electrochemical properties for molecular electronics, photovoltaics, batteries and photocatalytic applications. By coupling PDI to a subunit possessing considerable internal free volume, a material with high internal surface area and thermal stability was developed. These structural properties, combined with the robust redox behavior of the PDI subunit, produce n-type pseudocapacitance of 350 F/g, improved performances at a current density as high as 10 A/g, and stability for >10,000 cycles alongside a Coulombic efficiency of <98%. These results are improved values as an organic n-type pseudocapacitor material. Furthermore, the disclosed molecular design of the disclosed subject matter can allow modifying the structure of the scaffold by cyclizing the backbone via flow photocyclization. This modification produces changes in the pseudocapacitive performance of the material, converting it from a more battery-like behavior to a more capacitor-like behavior.

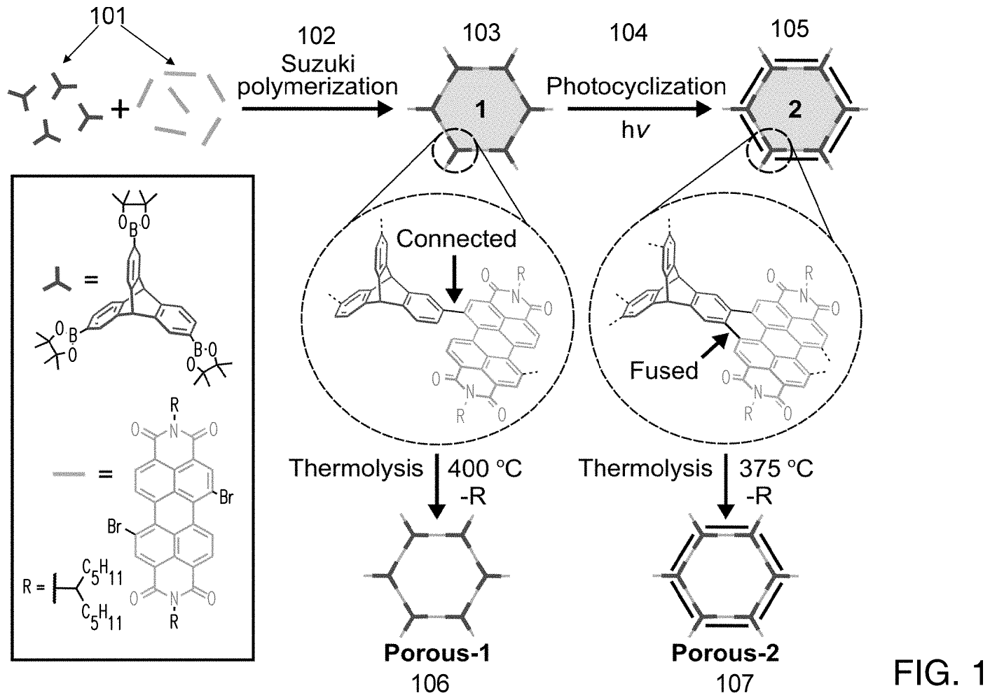

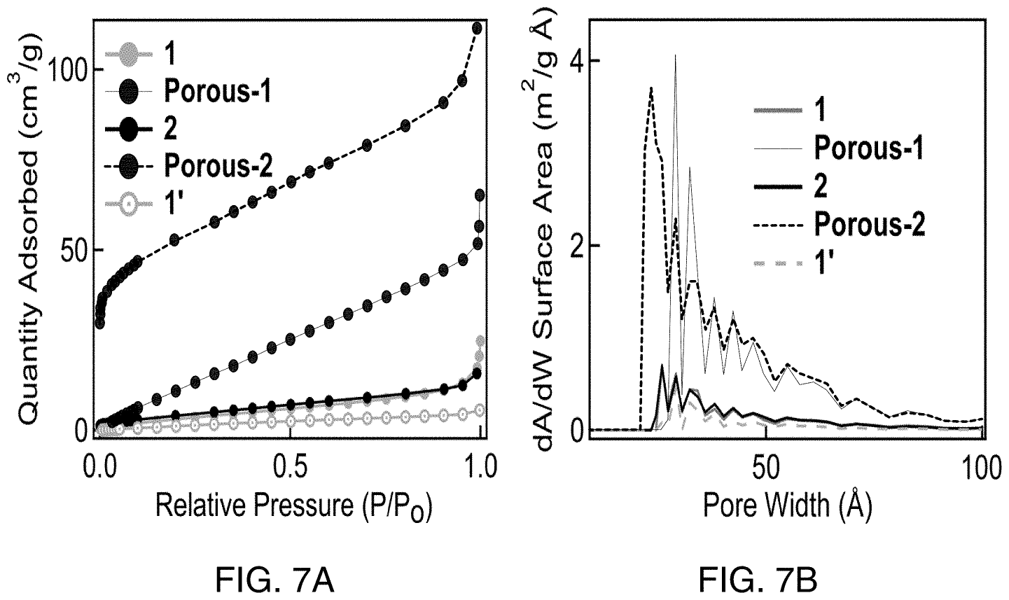

FIG. 1 presents the two monomers 101 used to make the porous scaffold through a Pd-catalyzed Suzuki polymerization 102. The triptycene unit was synthesized by using C—H activation chemistry to achieve a single procedure borylation of triptycene. The Suzuki co-polymerization 102 of these monomers 101 yielded the insoluble polymeric material 1 (103). N2 adsorption isotherms indicate that the material possesses a small internal surface area (15 m2/g) because the alkyl chains occupy the pores (FIG. 7A).

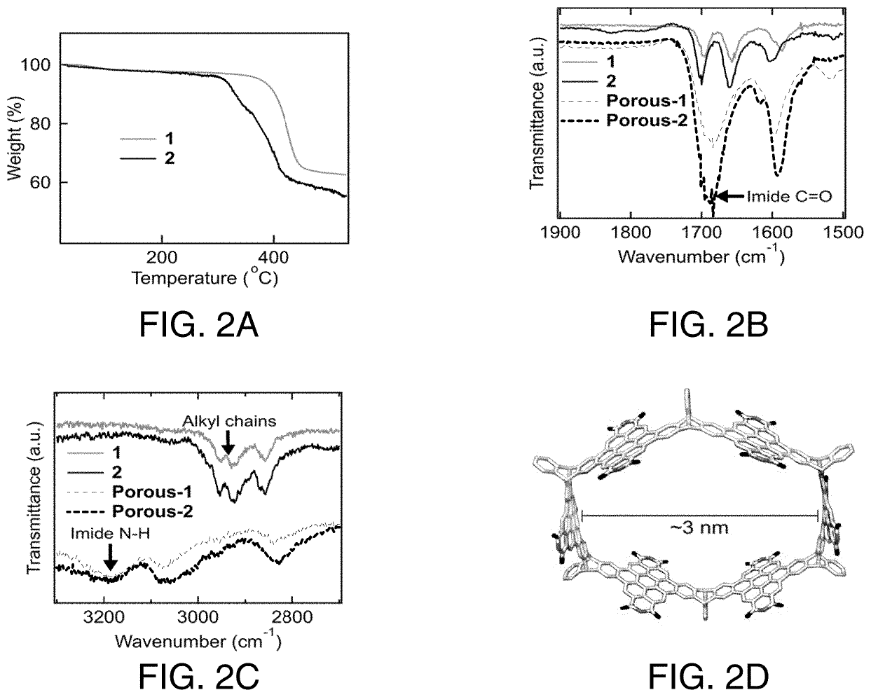

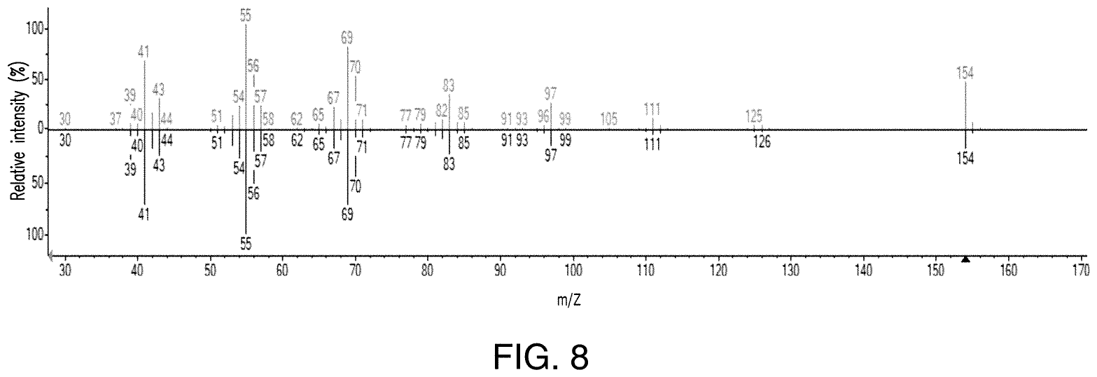

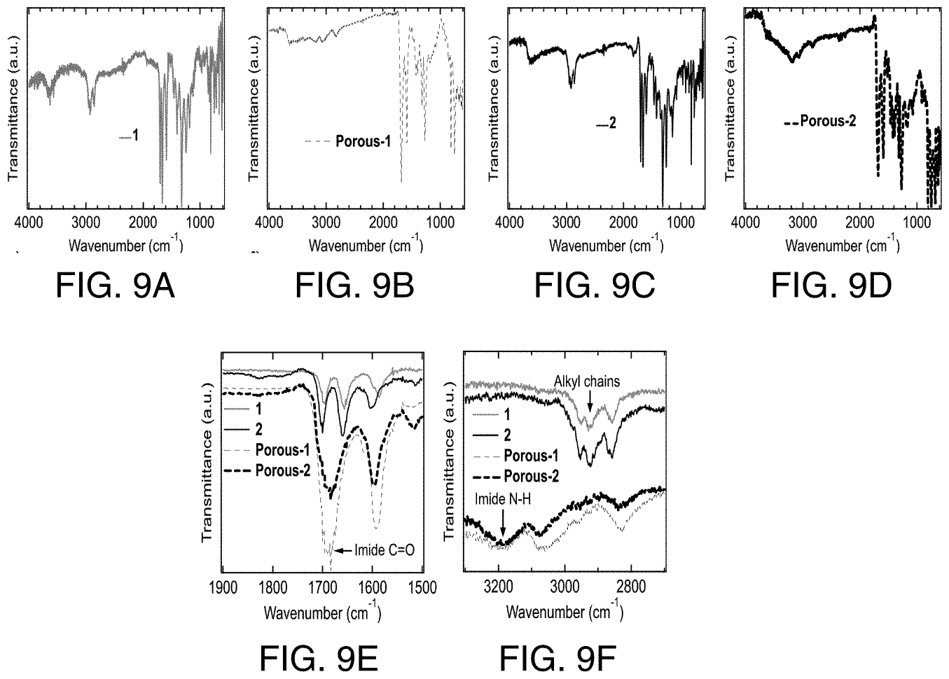

These chains, however, can be removed from the pores by thermolysis. Thermogravimetric analysis (TGA) of 1 illustrates this process: ˜40% of the sample mass, corresponding to the mass of the alkyl chains, is lost at ˜400° C. (FIG. 2A). To remove the chains, 1 is sealed under vacuum in a glass tube and heated to 400° C. in a tube furnace for 2 h, leaving one end of the tube cold. The condensate at the cold end was undecane (FIG. 8). The thermolyzed solid, Porous-1, has a larger surface area (71 m2/g) than 1. Infrared (IR) spectroscopy indicates the presence of primary imides in the thermolyzed solid and confirms the loss of vibrational modes from the alkyl groups (FIGS. 2B-C and FIG. 9).

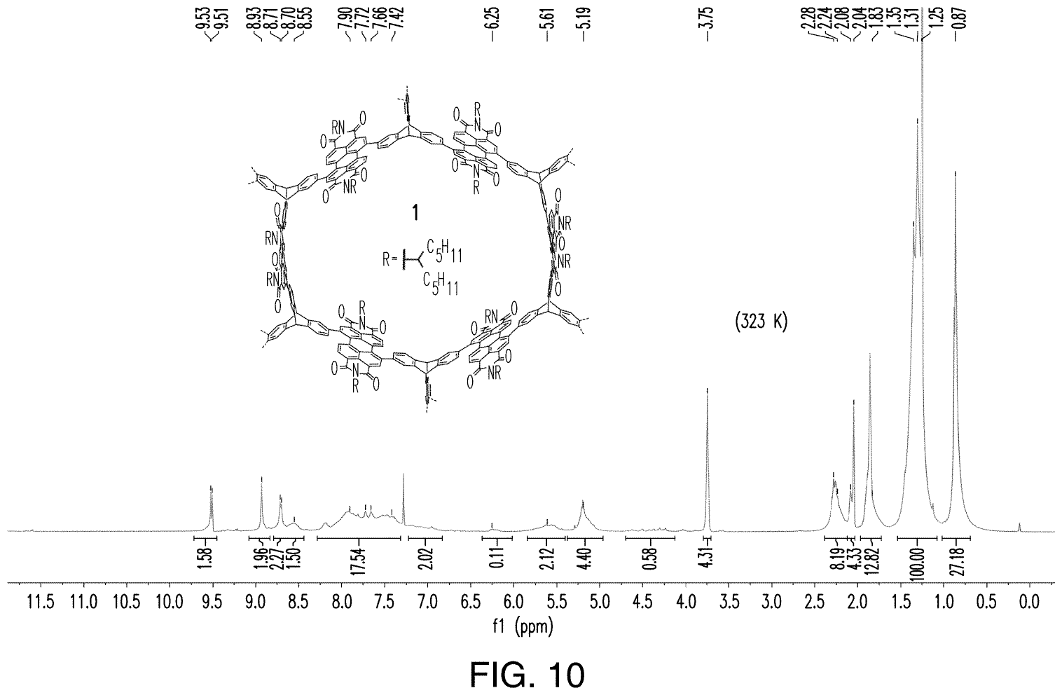

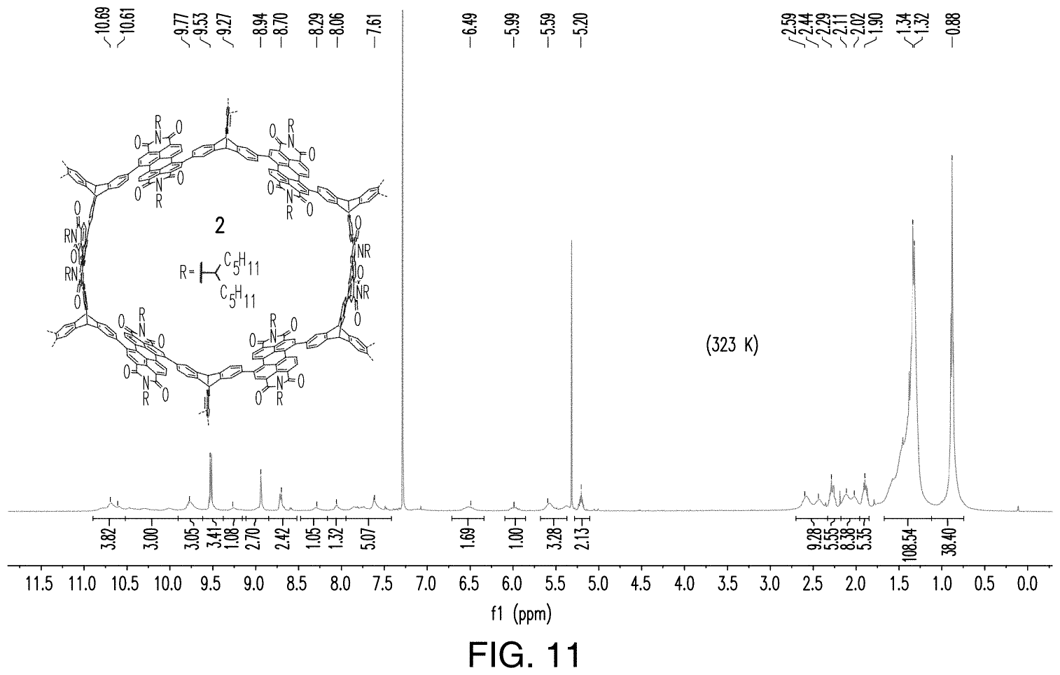

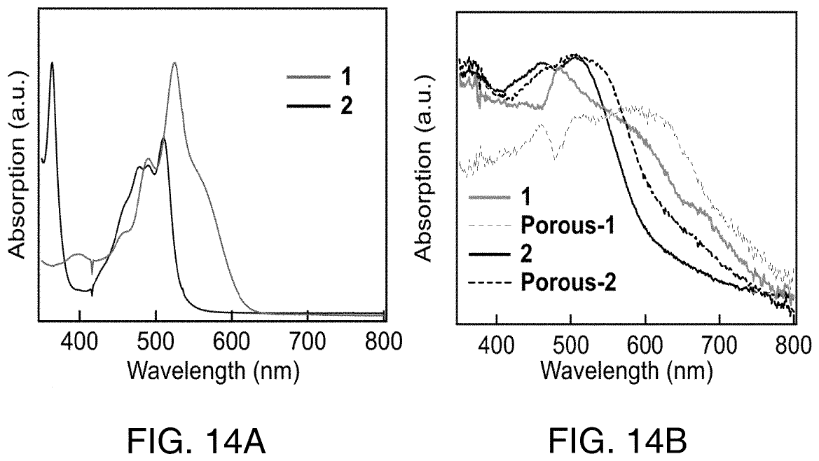

A soluble low-molecular weight material (1′) can be prepared by reducing the concentration of the reagents in the reaction to slow down the rate of polymerization. As show in FIG. 1, this soluble material was then photocyclized 104 in solution using visible light to yield 2 (105). NMR spectroscopy verifies the cyclization: resonances assigned to protons from uncyclized 1′ are absent in the spectrum of 2 (FIGS. 10 and 11), and the optical absorption characteristics exhibit sharpened λ max band edges (FIG. 14). Similar to 1, compound 2 can be heated to 375° C. to remove the alkyl chains from the pores, increasing the internal surface area of the material from 16 m2/g for 2 to 185 m2/g for Porous-2 (107). Porous-2 has a larger surface area than Porous-1(106) because the photocyclization stiffens the structure and increases the aromatic surface area.

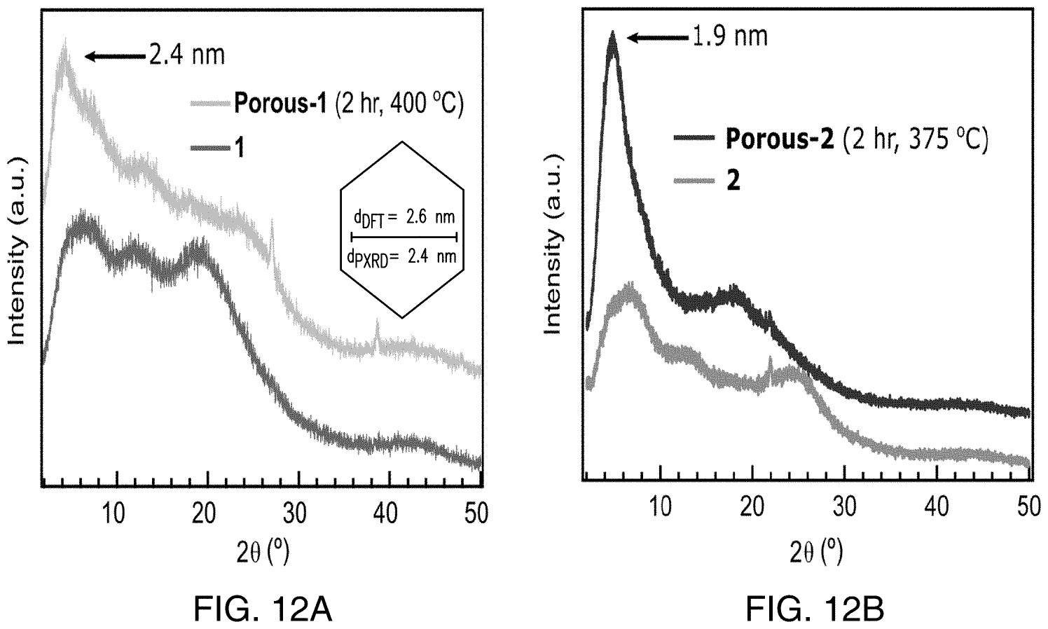

The structure of Porous-2 can be visualized with density functional theory (DFT) calculations of a single truncated macrocycle, which indicate that the pore diameter can be ˜3 nm (FIG. 2D). These calculations support the pore size distribution calculated from the N2 adsorption isotherm data. (FIG. 7B). The powder X-ray diffraction patterns of all the materials are typical of disordered mesoporous materials: they feature a broad low-angle peak with d-spacings corresponding to the pore diameter (FIG. 12).

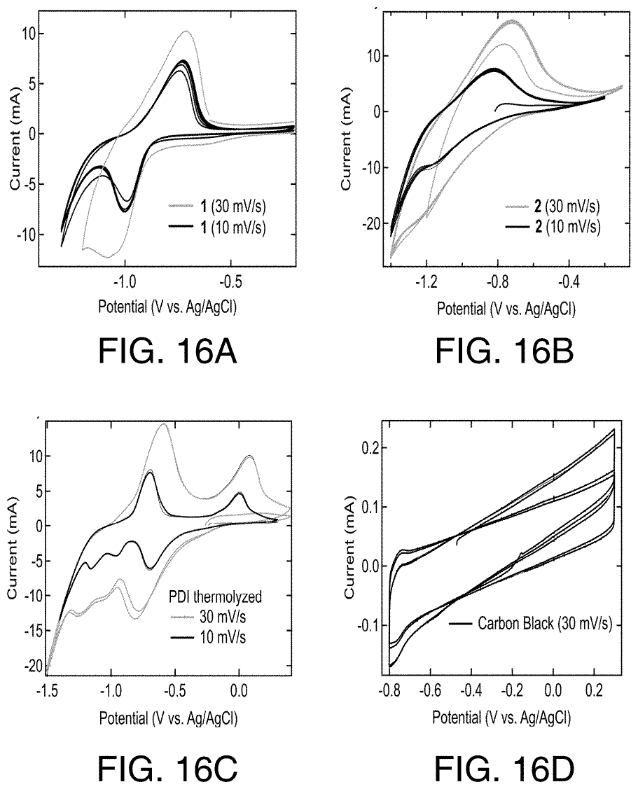

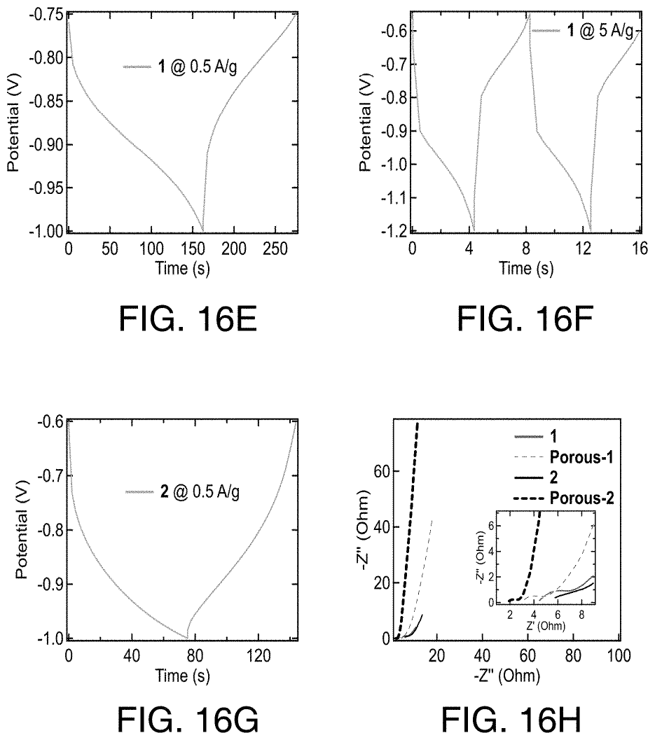

To confirm the electrochemical properties of the porous scaffold, electrodes were fabricated by depositing a slurry of Porous-1 or Porous-2, carbon black (10 wt. %), and polytetrafluoroethylene (10 wt. %) onto Ni foam. The electrochemical analyses were performed in 1 M Na2SO4. Porous-1 showed improved performance at low charging rates and Porous-2 performs better at higher rates; this change in behavior can be a direct consequence of their structural differences. As expected, the materials before removal of the sidechains (1 and 2) displayed decreased electrochemical performance, with low capacitance and high resistance due to the insulating alkyl chains in the pores (FIG. 16). After thermolysis, the performance of both materials improved.

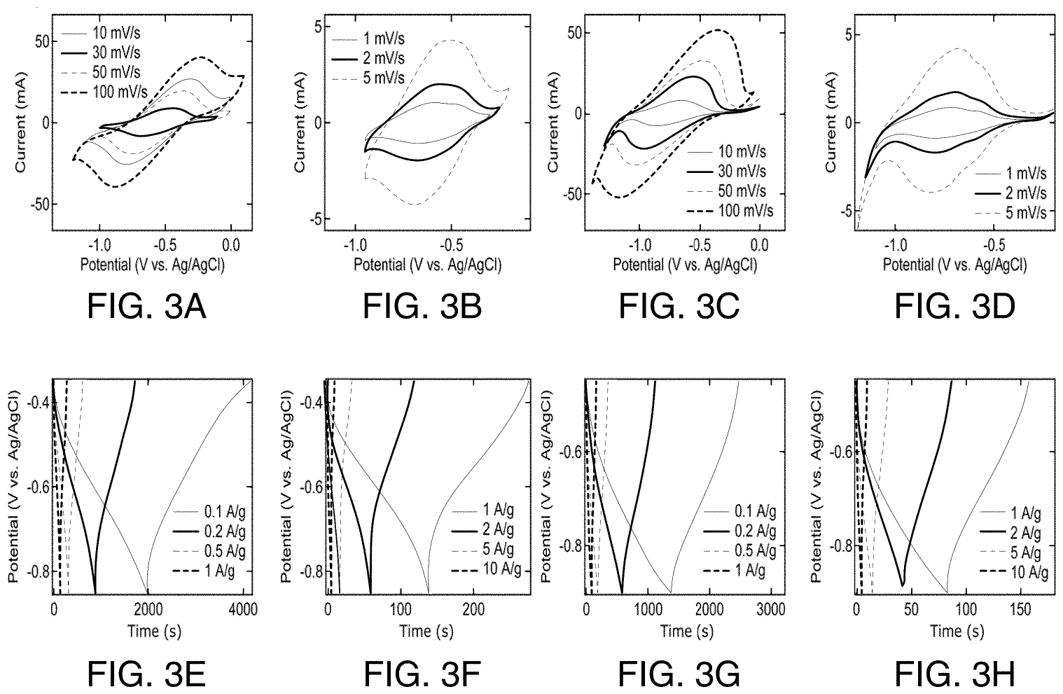

FIGS. 3A-D presents cyclic voltammograms (CVs) of Porous-1 and Porous-2 at various scan rates. Both materials display a broad reversible redox couple at negative potential. The negative bias and broadening of the couple results from surface-level reversible reduction processes. At low scan rates, the broad peak resolved into two distinct events (FIGS. 3B and 3D), assigned to the sequential reduction of the two diimide moieties on the PDI subunit. The potential of these two events agree with those of a control device fabricated with PDI only (FIG. 16C), as well as with the behavior of a model compound made of three PDIs linked to a triptycene central unit. These results indicate that the electrochemical behavior of Porous-1 and Porous-2 arises from reductive processes at the PDI units.

The specific capacitance (C) of Porous-1 and Porous-2 was calculated from the galvanostatic charge-discharge (GCD) curves at various current densities (FIG. 3E-3H) using equation (1):

C=(i·t)/(m·ΔE) (1)

where i is current, t is discharge cycle time, m is mass of active material, and ΔE is potential difference. These curves have the symmetric triangular shape typical of capacitive behavior with a small non-linear component due to pseudocapacitance.

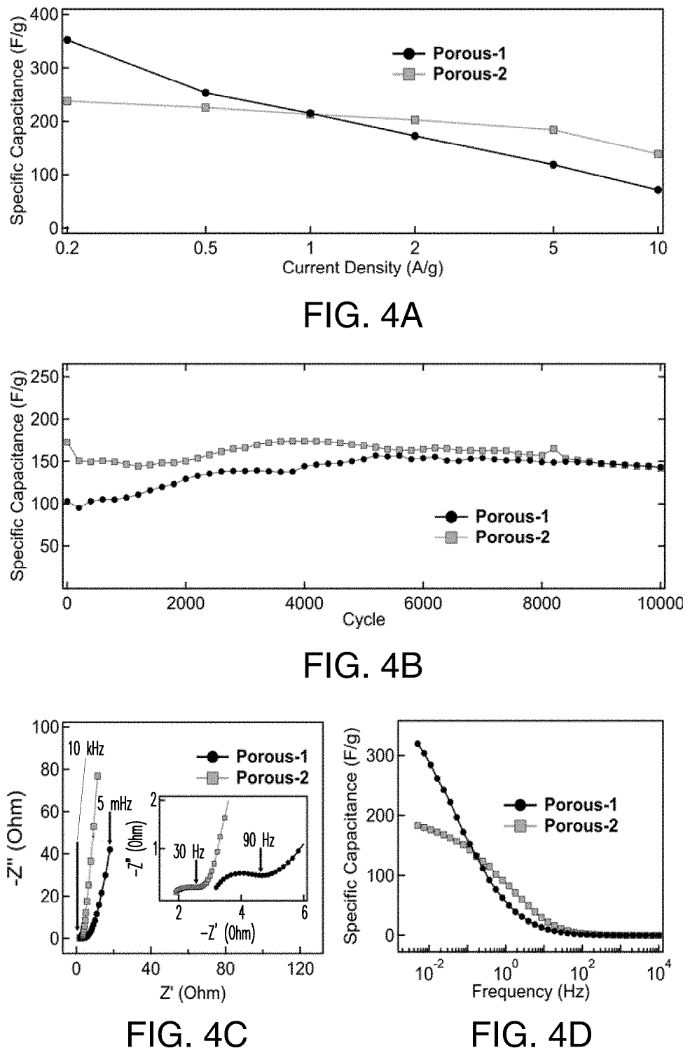

Certain capacitance for a range of current densities is shown in FIG. 4A. At the lowest current density (0.2 A/g), Porous-1 has a capacitance of 352 F/g, one of the highest reported values for stable n-type organic materials. The corresponding specific capacity is 59 mAh/g. These values approach the theoretical specific capacitance (548 F/g) and capacity (84 mAh/g) of the material, indicating that ˜70% of the redox sites are accessible. The capacitance of Porous-2 is lower than that of Porous-1 at low current density, but the capacitance of Porous-2 exceeds that of Porous-1 at rates above 1 A/g, and retains a capacitance of 138 F/g at 10 A/g. Overall, Porous-1 had higher capacitance at low cycle rates but Porous-2 outperformed at higher rates.

These differences indicate a correlation between the structure and transport behavior of the materials. A power law was used to extract kinetic information from the CVs shown in FIGS. 3A-D. The peak current ip is defined as:

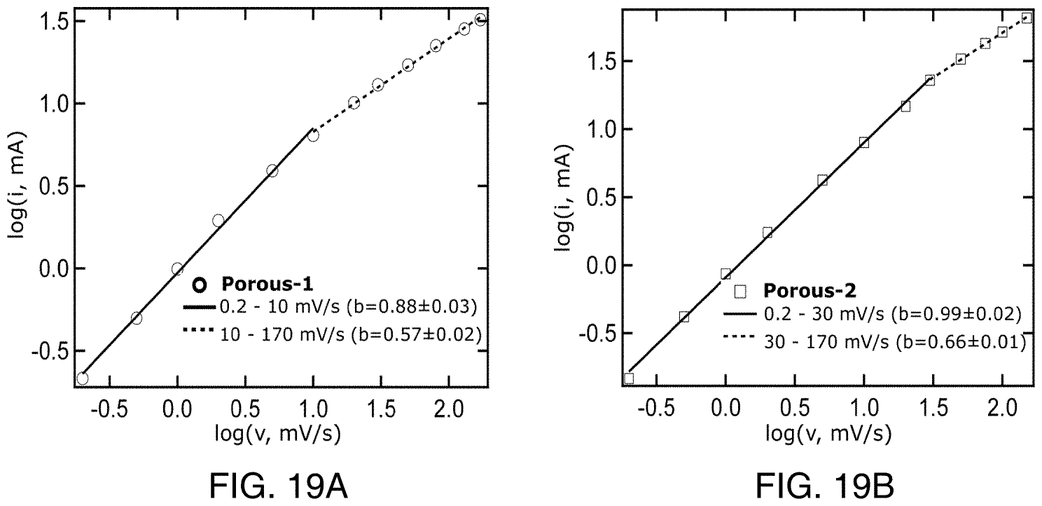

iₚ=a·v^{b} (2)

where v is the scan rate, and a and b are constants. b typically ranges from 0.5 to 1, depending on whether the system is diffusion-limited or capacitive, respectively. For Porous-1, b ˜0.9 and ˜0.6 for v≤10 mV/s and v≥10 mV/s, respectively, suggesting a surface-controlled capacitive behavior at low scan rate only (FIG. 19). By contrast, b ˜1 for Porous-2 at scan rates up to 30 mV/s. At higher scan rates, b ˜0.7, indicating contributions from both kinetic limits. Comparing both materials, it is clear that Porous-2 maintains a larger degree of capacitive behavior at higher scan rates, supporting the conclusion that the cyclized scaffold shows faster diffusion kinetics than the uncyclized Porous-1. Though Porous-2 is not formally fully conjugated, it has previously been shown that the PDI-triptycene geometry exhibits through-space electron delocalization.

The difference in performance for the two materials can be a consequence of the molecular structure of the scaffold: cyclized Porous-2 can be more structurally rigid, allowing for faster ion transport kinetics. Porous-1 and Porous-2 both displayed improved cycling stability with small capacitance decay seen over 10,000 cycles at a current density of 5 A/g (FIG. 4B). In fact, the capacitance of Porous-1 increased slightly with cycling due to increased ion accessibility of the pores.

The frequency-dependent transport behavior of the materials was further confirmed by electrochemical impedance spectroscopy. The plots of the real (Z′) versus imaginary (Z″) components of the impedance (Nyquist plots) for Porous-1 and Porous-2 are shown in FIG. 4C. For both materials, a depressed semicircle representing the electrochemical reaction was observed at higher frequency (inset of FIG. 4C): both the charge transfer resistance, approximated from the diameter of the semicircle, and the internal resistance, approximated from the Z′ intercept, were lower for Porous-2 than for Porous-1, supporting the faster kinetics of Porous-2.

The low frequency linear response of the Nyquist plot represents the diffusion-limited processes. A slope (or phase shift) of 45° indicates a Warburg impedance across a diffusive layer while a vertical line was expected for double-layer capacitance. The low frequency slope of Porous-2 was steeper than that of Porous-1, also confirming its more capacitive nature.

The specific capacitance of the materials as a function of frequency can be calculated from the impedance data using a series circuit model:

C(f)=(−1)/(m·Z″·2πf) (3)

where f is frequency (FIG. 4D). At the lowest measured frequency of 5 mHz, the capacitance of Porous-1 and Porous-2 are 320 F/g and 190 F/g, respectively, which are in agreement with the GCD results.

By co-polymerizing redox-active PDI subunits with triptycene subunits, a porous scaffold, which is capable of n-type pseudocapacitor behavior, was developed. The electroactive scaffold exhibits outstanding performance with peak capacitance of 352 F/g and stability over >10,000 cycles. Moreover, the electrochemical and transport behavior of the material can be tuned by modifying the structure post-synthesis.

### Synthetic Procedures

Reactions were carried out under inert atmosphere using standard Schlenk techniques, unless otherwise noted. Dry and deoxygenated solvents were prepared by elution through a dual-column solvent system (Glass Contour).

Triptycene tris-boronic acid pinacol ester and a mixture of 1,6- and 1,7-dibromoperylene-3,4,9,10-tetracarboxylicdiimide were synthesized. [1,1′-Bis(diphenylphosphino)ferrocene]dichloropalladium(II), potassium carbonate, triptycene, (1,5-cyclooctadiene)(methoxy)iridium(I) dimer, 4-tert-butyl-2-(4-tert-butylpyridin-2-yl)pyridine, and bis(pinacolato)diboron were purchased from Millipore Sigma.

The flow reactor is a home-built reactor consisting of a peristaltic pump (Masterflex L/S PTFE-Tubing Pump System; 3 to 300 rpm, 90 to 260 VAC; Item #UX-77912-10), FEP tubing (Chemfluor FEP tubing), and 17,500 lumen LED cornbulb lamps (EverWatt, EWIP64CB150WE39NB24, 150 W). The tubing was wrapped around the LED bulbs to provide the reaction surface. During the reaction, the temperature is ˜55-65° C.

Synthesis of 1 (Uncyclized): a 3 mL vial was charged with a stir bar, triptycene tris-boronic acid pinacol ester (105 mg, 0.167 mmol), a mixture of 1,6- and 1,7-dibromoperylene-3,4,9,10-tetracarboxylicdiimide (214 mg, 0.250 mmol), Pd(dppf)Cl₂ (12 mg, 0.016 mmol), and potassium carbonate (300 mg, 2.17 mmol). The charged vial was capped with a rubber septum, evacuated and backfilled with N2. Degassed water (0.4 mL) and degassed tetrahydrofuran (2.5 mL) were syringed into the vial. The mixture was then heated to 57° C. and stirred overnight. The solution was cooled to room temperature and diluted with water and dichloromethane. The mixture was filtered through Celite and washed with chloroform. The remaining solid was ground in a mortar and pestle, washed with water, methanol, chloroform, hexanes, and dichloromethane. The solid was then purified using a Soxhlet extractor with hexanes, methanol, dichloromethane, and chloroform, consecutively. The resulting dark purple solid (1) was dried in vacuo. Yield: 123 mg.

Synthesis of Porous-1: the synthesized 1 (122 mg) was sealed in a borosilicate glass tube under vacuum. The tube was placed in a tube furnace, with one end of the tube sticking out of the furnace and the other end containing the solid in the middle of the furnace. The furnace was heated to 400° C. for 2 hours, over which time the material turned black and a clear, yellow liquid condensed at the cool end of the tube. The tube was opened and Porous-1 was collected as a black solid. Yield: 75 mg. FIG. 7 illustrates the synthesized 1 and Porous-1.

Synthesis of 1′ (Soluble, uncyclized): a 20 mL vial was charged with a stir bar, triptycene tris-boronic acid pinacol ester (315 mg, 0.490 mmol), a mixture of 1,6- and 1,7-dibromoperylene-3,4,9,10-tetracarboxylicdiimide (650 mg, 0.759 mmol), Pd(dppf)Cl² (56 mg, 0.075 mmol), and potassium carbonate (888 mg, 6.44 mmol). The charged vial was capped with a rubber septum, evacuated and backfilled with N2. Degassed water (3 mL) and degassed tetrahydrofuran (12 mL) were syringed into the vial. The mixture was then heated to 57° C. and stirred overnight. The solution was cooled to room temperature and diluted with water and dichloromethane. The mixture was filtered through Celite and washed with chloroform. The resulting purple solution was dried in vacuo, and the collected purple solid was purified using a Soxhlet extractor with hexanes and methanol. The resulting dark purple solid (1) was dried in vacuo. Yield: 283 mg.

Synthesis of 2 (Cyclized): in a 100 mL round bottom flask, the soluble 1′ (100 mg) and iodine (25 mg) were dissolved in chlorobenzene (65 mL). The mixture was stirred for 15 minutes and then irradiated for 72 h with visible light using the home-built reactor described above. The solvent was then removed under vacuum and the resulting solid was suspended in methanol and loaded onto a Celite plug. The solid was washed with methanol, hexanes, and acetonitrile and then re-dissolved in chloroform. The solvent was removed under vacuum to give 2 as an orange powder. Yield: 90 mg.

Synthesis of Porous-2: the synthesized 2 (100 mg) was sealed in a borosilicate glass tube under vacuum. The tube was placed in a tube furnace, with one end of the tube sticking out of the furnace and the other end containing the solid in the middle of the furnace. The furnace was heated to 375° C. for 2 hours, over which time the material turned black and a clear, yellow liquid condensed at the cool end of the tube. The tube was opened and Porous-2 was collected as a black solid. Yield: 54 mg.

### Experiment Instruments

1H NMR Spectroscopy: 1H spectra were recorded on a Bruker DMX500 (500 MHz) spectrometer. Chemical shifts for protons are reported in parts per million downfield from tetramethylsilane and are referenced to residual protium within the NMR solvent (CDCl3: δ 7.26).

Thermogravimetric Analysis: thermogravimetric analysis (TGA) traces collected on a TA Instruments TGA Q500 under nitrogen.

Powder X-Ray Diffraction: the powder X-ray diffraction (PXRD) patterns were measured on a PANalytical XPert3 Powder X-ray diffractometer, on a rotating Si zero-background plate.

Infrared Spectroscopy: IR spectra were collected on a Perkin Elmer Spectrum 400 FT-IR.

N2 Adsorption Isotherm: N2 adsorption isotherms were collected on a Micromeritics ASAP 2020 HV BET Analyzer. Surface area was calculated using the Brunauer-Emmett-Teller (BET) method. Pore size distributions were calculated from N2 adsorption isotherms using the Tarazona non-local DFT method.

Scanning Electron Microscopy: Scanning electron micrographs were collected using a ZEISS Sigma FE-SEM.

Electronic Absorption Spectroscopy: solution phase electronic absorption spectra were collected on a Shimadzu UV 1800 UV/vis spectrophotometer. Diffuse reflectance solid state electronic spectra were recorded on a Perkin Elmer UV/Vis/NIR Lambda 950 spectrophotometer, using a Harrick Praying Mantis accessory.

Mass Spectrometry: gas chromatography mass spectrometry data were collected on an Agilent Technologies GC-MS consisting of a 7890B GC inlet, 5977B mass spectrometer (electron impact ionization, EI), and a PAL LSI 85 autosampler.

Electrochemical Measurements: electrochemical measurements were performed on a Bio-Logic VMP-3 potentiostat/galvanostat.

### Characterization

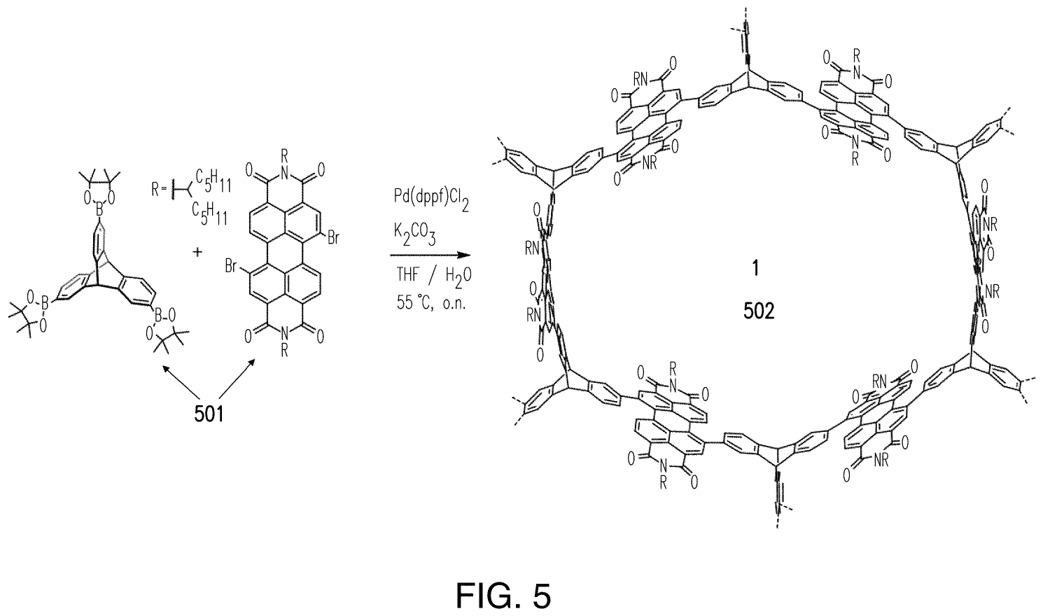

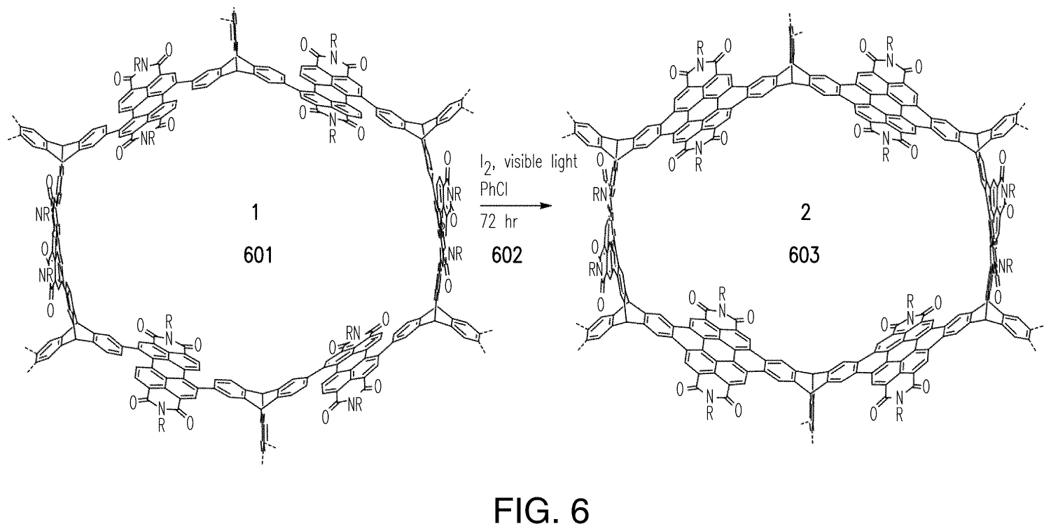

FIG. 5 is a schematic work flow for synthesizing an example polymer 1 (502) by polymerizing monomers 501. FIG. 6 is a schematic work flow for synthesizing an example polymer 2 (603) by photocyclized the polymer 1 (601) using visible light 602.

FIG. 7 shows N2 adsorption isotherms and pore size distribution of 1, Porous-1, 2, Porous-2, and 1′ (low molecular weight 1). The peaks of the distributions range from 2.4 to 3 nm in agreement with the diameter of the macrocyclic unit modeled by DFT. FIG. 8 shows a graph illustrating mass spectrometry data of the liquid collected at the cold end of the tube after thermolysis of 2. The mass spectrum matches with the NIST reference spectrum of 5-undecane.

FIG. 9 provides IR spectra of 1, Porous-1, 2, and Porous-2 including the carbonyl region. The imide C═O peaks (1690 cm−1) were retained following thermolysis. Furthermore, the IR spectra for 1, 2, Porous-1 and Porous-2 show the alkyl spectral region. The alkyl peaks (3050-2800 cm−1) were lost upon thermolysis, and an imide N—H peak (˜3150 cm−1) appears.

As shown in FIG. 10, the presence of broad resonances occurred in the δ7.3-8.2 region according to NMR spectrum data of 1. FIG. 11 shows that the disappearance of broad resonances occurred in the δ7.3-8.2 region according to NMR spectrum data of 2.

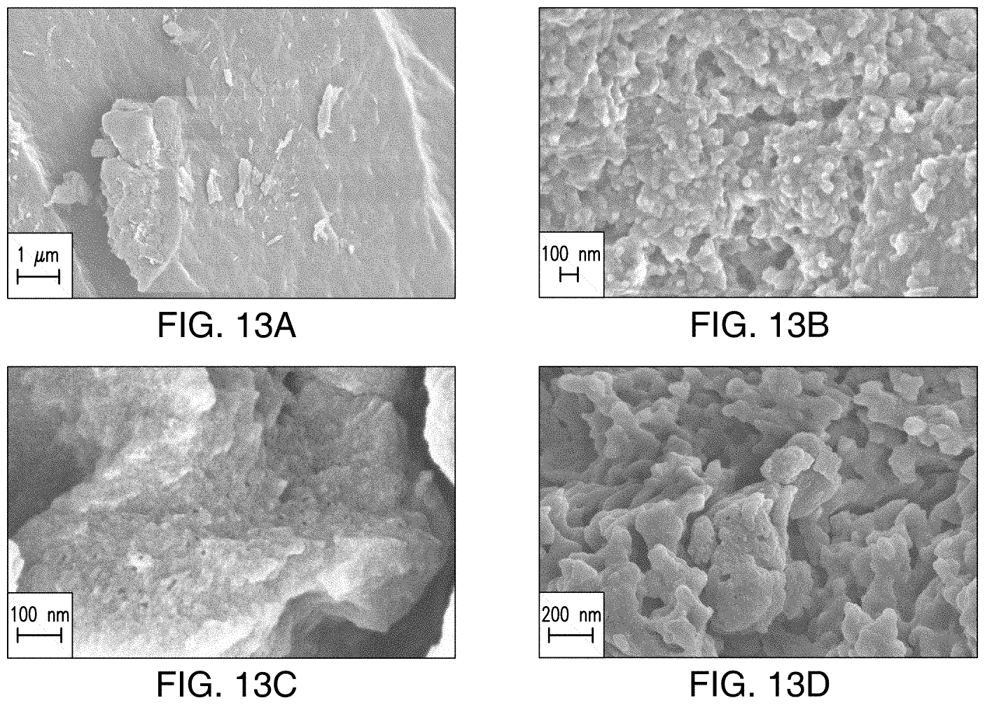

FIG. 12A shows PXRD patterns of 1 and Porous-1. The inset compares the d-spacing determined from the PXRD patterns with that calculated for a hexagonal pore structure, as modeled by DFT. FIG. 12B shows PXRD patterns of 2 and Porous-2. FIG. 13 shows SEM images of 1, Porous-1, 2, and Porous-2. FIG. 13A provides normalized electronic absorption spectra of 1 and 2 in dichloromethane solution. FIG. 13B provides diffuse reflectance solid state electronic absorption spectra of 1, 2, Porous-1 and Porous-2.

Electrode Fabrication: the active material was ground in an agate mortar and pestle. The material was combined with carbon-black and polytetrafluoroethylene (60% w/v suspension in water) in an 80/10/10 mass ratio. N-methyl-2-pyrrolidone (NMP) was added to the mixture and the slurry was stirred for ˜2 h. Ni foam was cut into a flag shape with an active area of ˜0.6 cm². The Ni foam was sonicated in 16% HCl for 5 min to clean the surface of native oxide. The Ni foam was then washed with water and acetone, dried, and weighed on an analytical balance. Two drops of the slurry were deposited onto the Ni foam. The electrode was dried at 80° C. for ˜2 hours. The electrode was then mechanically pressed under 10 MPa for 5 minutes, weighed, and placed back in a vacuum oven to dry at 80° C. under vacuum overnight. The electrode was taken out and immediately soaked in 1 M aqueous Na₂SO₄.

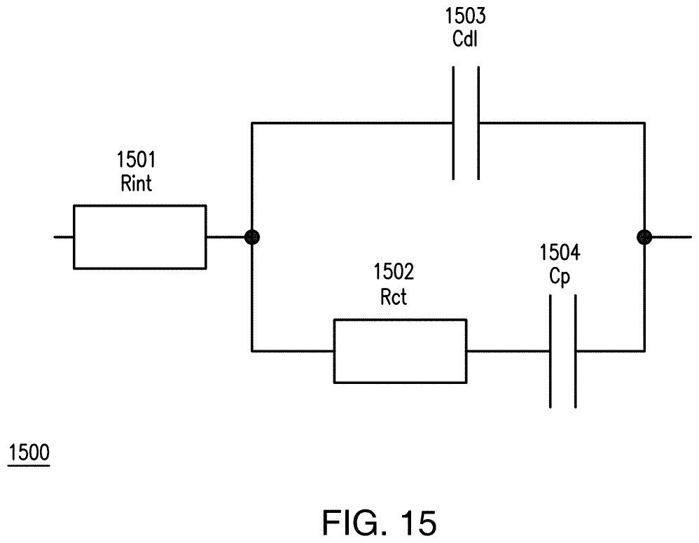

Electrochemical Measurements: measurements were performed in 1 M aqueous Na₂SO₄ prepared from ultra-pure distilled water. Measurements were performed in a three-electrode cell with 5 mL of electrolyte, using the active material on Ni foam as the working electrode, Pt wire as the counter electrode, and an Ag/AgCl (3 M NaCl) aqueous reference electrode. Prior to measurement the electrolyte was sparged for 10 minutes with N2 and the cell was subsequently kept under N2 atmosphere. Cyclic voltammetry was performed in the range of −1.2 to 0.1 V vs. Ag/AgCl, with scan rates from 0.2 to 200 mV/s. Galvanostatic charge-discharge measurements were performed by applying a constant current ranging from 100 uA to 20 mA, with the current switching signs upon reaching a set voltage limit. Voltage limits were set at −0.35 and −0.85 V for Porous-1, and −0.45 and −0.9 V for Porous-2. Potentiostatic electrochemical impedance spectroscopy measurements were performed in the frequency range 10 kHz to 5 mHz with a sinus amplitude of 5 mV. FIG. 15 shows an equivalent circuit 1500 for the pseudocapacitive system, where Rint 1501=internal resistance, Rct 1502=charge transfer resistance, Cdl 1503=double layer capacitance, and Cp 1504=pseudocapacitance. The following equations were used for the measurements:

Capacitance; galvanostatic charge−discharge (GCD): C=(i*t)/ΔV (4)

Capacity: Q=(I*t)/3600 (5)

Capacitance; EIS, series model: C_s=(−1)/(Z″*2π*f) (6)

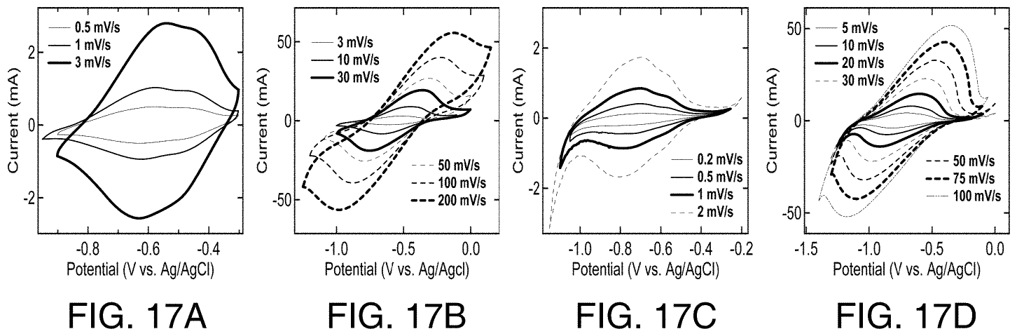

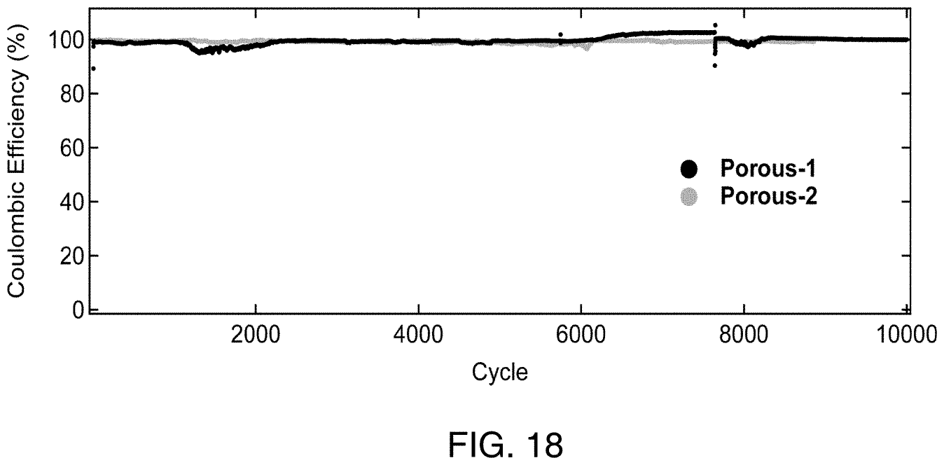

FIG. 16 provides (16A) CV of 1 at two scan rates, (16B) CV of 2 at two scan rates, (16C) CV of thermalized PDI at two scan rates, (16D) CV carbon black, (16E) single GCD cycle of 1 at a current of 0.5 A/g, (16F) two GCD cycles 1 at a current of 5 A/g, where the capacitance of 1 is 208 F/g at low current (0.5 A/g) but decreases significantly to 37 F/g at higher current (5 A/g), (16G) single GCD cycle of 2 at a current of 0.5 A/g, where the capacitance is 90 F/g, (16H) Nyquist plots of 1, 2, Porous-1 and Porous-2. FIG. 17 provides CVs of Porous-1 at low scan rates and high scan rates. FIG. 17 also shows CVs of Porous-2 at low scan rates and high scan rates. FIG. 18 shows coulombic efficiencies per cycle of Porous-1 and Porous-2.

Power Law Fitting: a b value of 0.5 indicates that the system is diffusion limited, while a b value of 1 indicates that the system is capacitive. The b value was extracted over different scan rates from the slope of linear fits applied to a plot of log(i) vs. log(v) from v=0.2 to 170 mV/s. For Porous-1, b ˜0.9 for scan rates below 10 mV/s, indicating a primarily capacitive system. Above 10 mV/s, b ˜0.6, indicating that the system becomes diffusion limited. For Porous-2, b ˜1 for scan rates below 30 mV/s, indicating capacitive behavior. At faster scan rates, b ˜0.65, indicating contributions from both kinetic behaviors. FIG. 19 shows plots of log(i) vs. log(v) for Porous-1 and Porous-2. The linear fits for the two regimes are shown as solid and dashed lines.

Specific Capacitance Values: Table 1 shows specific capacitance values for Porous-1 and Porous-2 calculated from GCD at various current densities, corresponding to FIG. 4A.

TABLE 1
Capacitance values of Porous-1 and
Porous-2 calculated from GCD.

| Current Density | Specific Capacitance | Specific Capacitance |
|---|---|---|
| (A/g) | (Porous-1, F/g) | (Porous-2, F/g) |
| 0.2 | 352 | 238 |
| 0.5 | 253 | 226 |
| 1 | 215 | 213 |
| 2 | 173 | 203 |
| 5 | 119 | 184 |
| 10 | 72 | 138 |

Table 2 shows specific capacitance values for Porous-1 and Porous-2 calculated from CV at various scan rates.

TABLE 2
Capacitance values of Porous-1 and Porous-2 calculated from CV.

| Sweep Rate | Specific Capacitance | Specific Capacitance |
|---|---|---|
| (mV/s) | (Porous-1, F/g) | (Porous-2, F/g) |
| 2 | 375 | 138 |
| 5 | 247 | 138 |
| 10 | 198 | 125 |
| 50 | 137 | 114 |
| 100 | 73 | 97 |
| 150 | 63 | 95 |

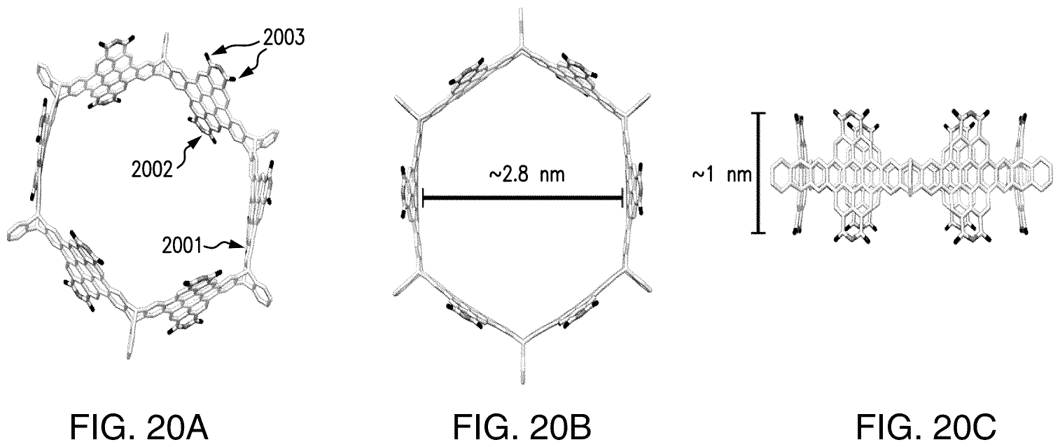

Computational modeling: quantum chemical calculations were performed. Geometries were optimized using the B3LYP or M06-2X functional and the 6-31G basis set. The geometry of Porous-2 is offered as an approximation of the geometry of both Porous-1 and Porous-2, as Porous-2 is a rigid application of Porous-1. FIGS. 20A-C provide (20A) a DFT energy-minimized structure of Porous-2 with hexagonal pore subunit including carbon 2001, nitrogen 2002 and oxygen 2003, (20B) a hexagonal pore subunit with a diameter of 2.8 nm, and (20C) a cylindrical pore subunit with a height of −1 nm in accordance with the disclosed subject matter.

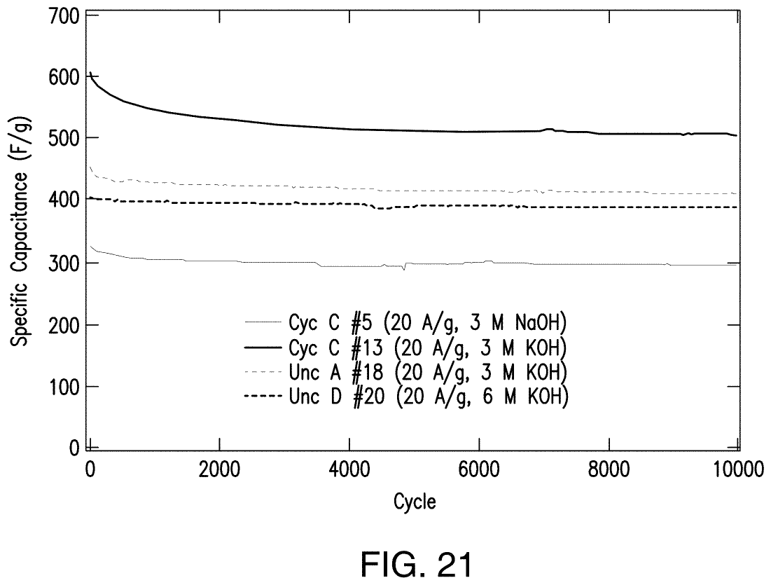

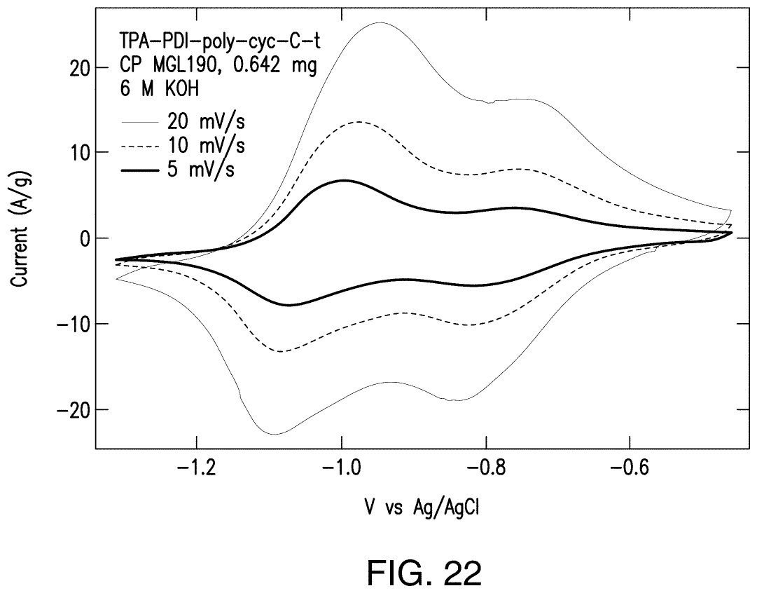

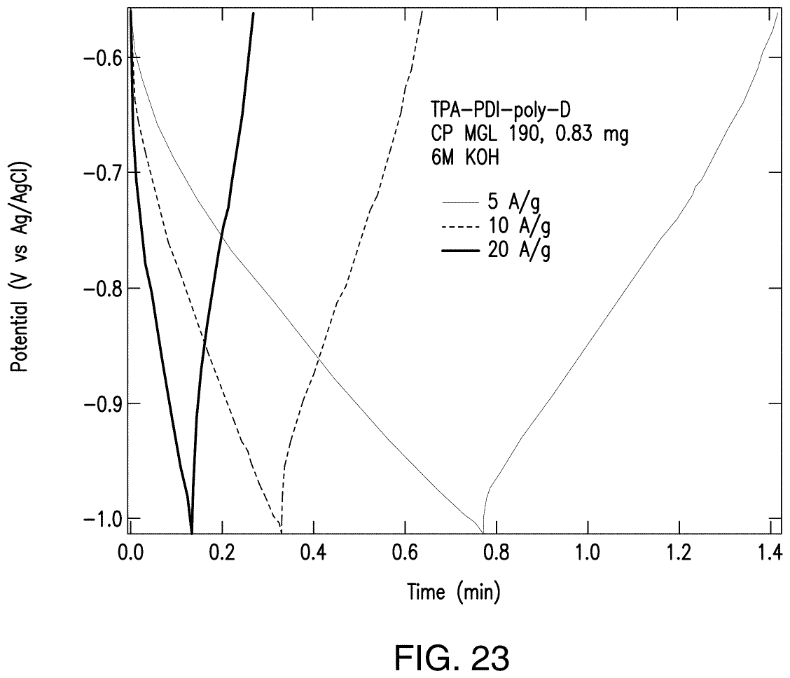

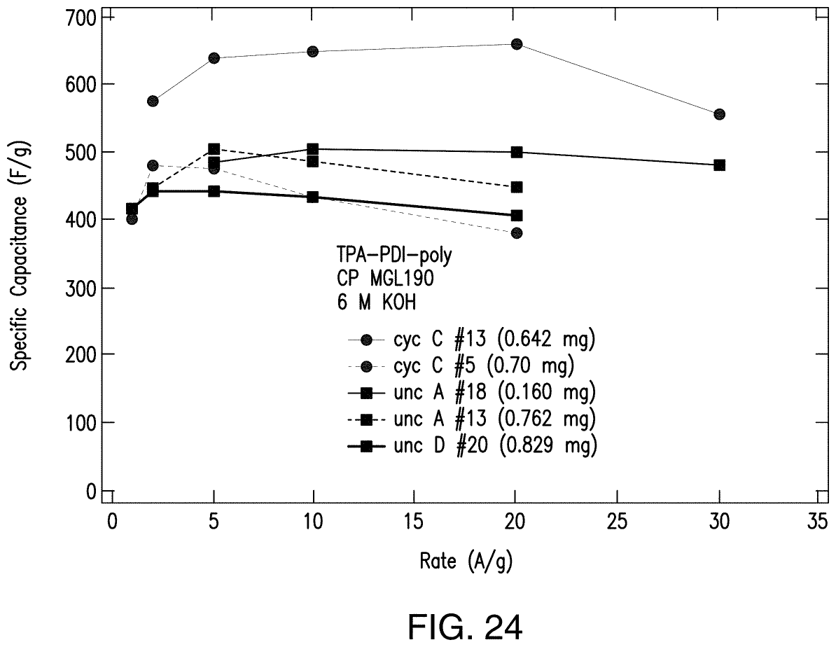

FIG. 21 shows a graph illustrating cycling stability of the disclosed polymer under various conditions in accordance with the disclosed subject matter. FIG. 22 shows a graph illustrating cyclic voltammograms of the disclosed polymer under various conditions in accordance with the disclosed subject matter. FIG. 23 is a graph illustrating galvanostatic curves of the disclosed polymer under various conditions in accordance with the disclosed subject matter. FIG. 24 is a graph illustrating performance (i.e., capacitance vs. rate) of the disclosed polymer under various conditions in accordance with the disclosed subject matter.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein.

The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the methods and systems of the disclosed subject matter without departing from the spirit or scope of the disclosed subject matter. Thus, it is intended that the disclosed subject matter include modifications and variations that are within the scope of the appended claims and their equivalents.

What is claimed is:

1. A polymer comprising:
a perylene diimide subunit; and
a triptycene subunit.

2. The polymer of claim 1, wherein at least a portion of the triptycene subunit is covalently coupled to one or more perylene diimide subunits.

3. The polymer of claim 1, wherein at least a portion of the triptycene subunit is covalently coupled to three perylene diimide subunits.

4. The polymer of claim 1, wherein the polymer has the following structure: 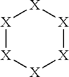
wherein:
X is 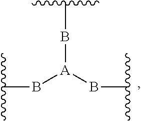
A represents the triptycene subunit, and
B represents the perylene diimide subunit.

5. The polymer of claim 1, wherein the polymer has a capacitance value between about 0 F/g and about 350 F/g at a current density about 0.2 A/g.

6. A method for forming a polymer comprising:
creating a polymer by co-polymerizing a perylene diimide building block and a triptycene building block;
thermolyzing the polymer;
washing the polymer with organic solvents;
photocyclizing the polymer to generate a triptycene-perylene diimide polymer; and
thermolyzing the triptycene-perylene diimide polymer.

7. The method of claim 6, further comprising forming a slurry of the triptycene-perylene diimide polymer, carbon black, and polytetrafluoroethylene, and depositing the slurry onto a nickel (Ni) form.

8. The method of claim 6, wherein the co-polymerizing comprises a Suzuki polymerization.

9. The method of claim 6, wherein the perylene diimide building block comprises 1,6-, 1,7-dibromoperylene-3,4,9,10-tetracarboxylicdiimide, or a mixture of thereof.

10. The method of claim 6, wherein the triptycene building block comprises a triptycene tris-boronic acid pinacol ester.

11. The method of claim 6, further comprising modifying a pore structure of the triptycene-perylene diimide polymer via flow photocyclization.
